(19) United States
(12) Patent Application Publication
(10) Pub. No.: US 2009/0084840 A1
(43) Pub. Date: Apr. 2, 2009

(54) SYSTEM AND METHOD FOR PAYMENT AT A POINT-OF-SALE TERMINAL

(75) Inventors: Rodger Williams, Siler City, NC (US); Ed Payne, Greensboro, NC (US)

Correspondence Address: NELSON MULLINS RILEY & SCARBOROUGH, LLP, 1320 MAIN STREET, 17TH FLOOR, COLUMBIA, SC, 29201, US

(73) Assignee: GILBARCO, INC., Greensboro, NC (US)

(21) Appl. No.: 12/240,526

(22) Filed: Sep. 29, 2008

Related U.S. Application Data
(60) Provisional application No. 60/976,631, filed on Oct. 1, 2007.
(60) Provisional application No. 61/053,266, filed on May 15, 2008.

(51) Int. Cl. G06Q 40/00

(52) U.S. Cl. 235/379

(57) ABSTRACT

A point-of-sale terminal comprises a processor, memory operatively coupled to the processor, a display screen operatively coupled to the processor and configured to display transaction information and a reader operatively coupled to the processor and configured to read a first two-dimensional encoded image pattern comprising payment information and personal security information necessary to complete a transaction. The processor is configured to decipher the first two-dimensional encoded image pattern to obtain the payment information and personal security information and complete the transaction based on this information. The personal security information comprises at least one of GPS information, time and date information, handheld device information and PIN information. The display may be configured to display a second two dimensional encoded image pattern generated by the processor that comprises transaction information readable by a handheld device that generates the first two-dimensional encoded image in response to the second two dimensional encoded image.

### CLAIM OF PRIORITY

The present application claims priority to U.S. Provisional Patent Application Ser. Nos. 60/976,631, filed Oct. 1, 2007, entitled System and Method for Payment at a Point-of-Sale Terminal and 61/053,266, filed May 15, 2008, entitled System and Method for Payment at a Point-of-Sale Terminal, the entire disclosures of which are incorporated by reference herein.

### FIELD OF THE INVENTION

The present invention relates to systems and methods for payment and, more particularly, to systems and methods for payment at a point-of-sale terminal using two-dimensional encoded image patterns.

### BACKGROUND

Retail transaction processing systems offer customers several different methods of payment. Payment options commonly include one or more types of payment cards. Such cards include magnetic-stripe credit and debit cards. To effect payment for a transaction, a customer swipes the card in a magnetic card reader or places the card in a bar-code scanner. An exemplary bar-code scanning system may be found in Applicant's U.S. Pat. No. 6,062,473, entitled “Bar Code Reader System” and is incorporated in its entirety herein by reference. In turn, the retail transaction processing system contacts an outside authorization network, submits the payment information obtained from the card, and allows or disallows the customer transaction based on return authorization information.

Frequently, a customer must enter a personal identification number referred to as a “PIN” and the retail transaction processing system transmits this PIN to the outside authorization network for verification. As the primary value of PIN use is fraud prevention, providing secure PIN handling within the retail transaction processing system is critical. In general, the PIN is entered into a keypad in or proximate to a point-of-sale (POS) terminal. The keypad includes electronics for encrypting the PIN information using a local key. Newer types of payment cards, such as electronic smart cards, have the capability to securely store verification information within the card itself. Thus, a POS terminal is capable of interfacing with a smart card to obtain transaction authorization based on information contained in the smart card itself. This allows verification and authorization activities to occur locally between the POS and the customer's smart card, with the retail transaction system reconciling transaction charges with an outside authorization network at a later time. Localized transaction authorization still requires positive identification of the customer and, as such, the customer is commonly required to enter a PIN in conjunction with use of their smart card. After inputting by the customer, this PIN information is transferred to the smart card, where its internal processing capabilities allow for comparison of the input PIN with stored PIN information contained in the smart card's memory.

Prior art designs require the user to input their PIN information on a keypad in an unencrypted format. Because of the sensitive nature of PIN information, such designs may allow other customers or onlookers to visually detect the customers PIN information.

### SUMMARY OF THE INVENTION

The present invention recognizes and addresses considerations of prior art constructions and methods.

In one embodiment of payment apparatus according to the present invention, a point-of-sale terminal comprises a processor, memory operatively coupled to the processor, a display screen operatively coupled to the processor and configured to display transaction information and a reader operatively coupled to the processor and configured to read a first two-dimensional encoded image pattern, the first two-dimensional encoded image pattern comprising payment information and personal security information necessary to complete the transaction. The processor is configured to decipher the first two-dimensional encoded image pattern to obtain the payment information and personal security information, and complete the transaction based on the payment information and the personal security information.

In other embodiments, the personal security information comprises at least one of GPS information, time and date information, handheld device information and PIN information. In yet other embodiments, the first two-dimensional encoded image pattern further comprises a plurality of light and dark squares that together form two-dimensional barcode. In some embodiments, the reader is a camera. In other embodiments, the display is configured to display a second two dimensional encoded image pattern generated by the processor, the second two dimensional encoded image pattern comprising transaction information that is readable by a handheld device that generates the first two-dimensional encoded image in response to the second two dimensional encoded image pattern.

In another embodiment, a method for conducting a transaction at a point-of-sale terminal comprises the steps of conducting a transaction at a point-of-sale terminal, generating at least, one encoded image pattern on a display device, the encoded image pattern comprising a plurality of contrasting colored squares that together represent encoded information for completing the transaction, placing the display device adjacent a two-dimensional image reader, reading the at least one encoded image pattern, deciphering the at least one encoded image pattern to extract the information for completing the transaction and using the information to complete the transaction. In some embodiments, the two dimensional reader is built into a handheld device and the at least one encoded image pattern is generated by the point-of-sale terminal. In yet other embodiments, the handheld device is a cellular telephone.

In some embodiments, the encoded information comprises at least one of payment information and transaction information. In other embodiments, a two-dimensional reader is operatively coupled to the point-of-sale terminal and the step of generating at least one encoded image pattern is carried out on a handheld device. In this embodiment, the reader is a camera.

In yet other embodiments, the encoded information further comprises credit card information and personal security information for completing the transaction. In this embodiment, the personal security information is at least one of GPS information, time and date information, handheld device information and PIN information.

In some embodiments, the encoded information further comprises a website link. In this embodiment, the method further comprises the step of entering payment data on a webpage associated with the encoded webpage link.

In some embodiments, a display on the handheld device functions as a scanner for reading the at least one coded image. In other embodiments, a camera built in to the handheld device functions as a scanner for reading the at least one coded image.

The accompanying drawings, winch are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of a coded image for use in an embodiment of the present invention;

FIG. 2 is a perspective view of a coded image for use in an embodiment of the present invention;

FIG. 3 is a perspective view of a coded image for use in an embodiment of the present invention;

FIG. 4 is a perspective view of a coded image for use in an embodiment of the present invention;

FIG. 5 is a perspective view of a coded image for use in an embodiment of the present invention; and

FIG. 6 is a mobile module for use with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations. Additional aspects and advantages of the invention will be set forth in part in the description which follows and, in part, will be obvious from the description, or may be learned by practice of the invention.

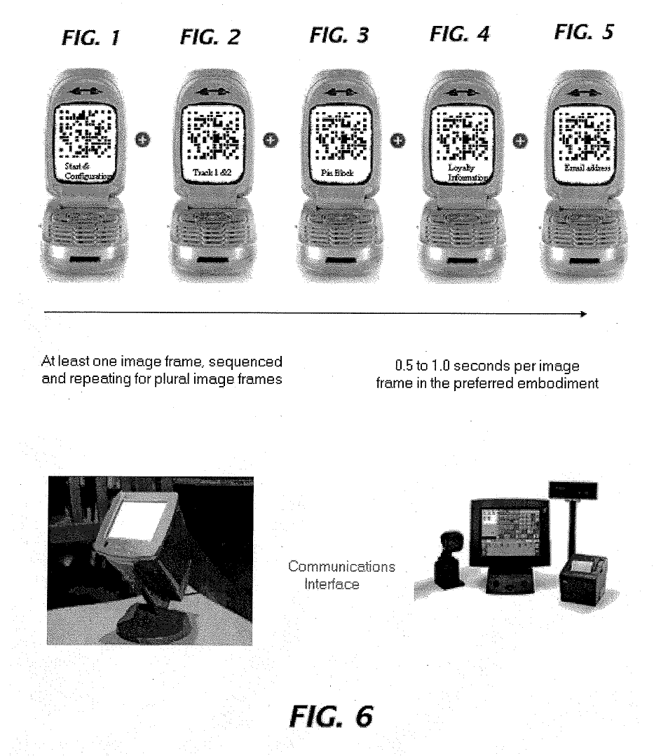

In a new and improved system, referring to FIGS. 1-5, a cell phone is used to encode credit/debit or other payment information for a customer. The fuel dispenser point-of-sale (POS) terminal, either dedicated per dispenser side, per dispenser, proximate to and/or centralized remote, is equipped with a scanner (CCD or other image capture device), in addition to the normal readers (such as magnetic card readers, RFID readers, finger print readers, etc). The encoded information is displayed as one or more encrypted or non-encrypted images that may be locally stored on and generated by the cell phone. In other embodiments, the information may be remotely stored, transmitted over the cell phone network and displayed on the cell phone LCD. The encoded information includes, but is not limited to, a credit/debit card number, PIN information, GPS information, date/time information, handheld device information or any other information necessary to complete a transaction. As a result, the image(s) are equivalent to a packet of information necessary to conduct a transaction at various types of POS terminals, such as a convenience store POS, fuel dispenser, etc.

When a transaction is initiated, the customer selects the payment method associated with the scanner, runs a program on their cell phone that generates at least one encoded image with the customer's payment information, and places the cell phone LCD adjacent the image scanner. By placing the cell phone LCD adjacent the image scanner, the POS terminal can capture and decipher the image(s) to extract payment and other information.

In one embodiment and referring to FIG. 1, a start and configuration image is generated. Next at FIG. 2, card information normally contained in one or more tracks of the magnetic strip is generated and displayed. Referring to FIG. 3, an encrypted image containing the user's PIN is generated and displayed. In other embodiments and referring to FIG. 4, loyalty information including, but not limited to, a loyalty code may be encoded and displayed. Finally, as shown in FIG. 5, the user's e-mail address may be encoded and displayed. The cell phone display may be configured to repeatedly display the images until a signal is sent from the POS indicating that the images have been received. In other embodiments, the images may be repeatedly displayed for a predetermined period of time. In yet other embodiments, the images may be repeated for a set number of times. In any event, the POS captures the encoded information from the images and processes the information as it would a credit/debit transaction.

It should be understood from the above that all information to complete a transaction may, in the alternative, be presented within a single static image frame. That is, if all information to complete a transaction can be encoded in a single image frame, then one image frame may be used to complete the transaction. The amount of data that can be placed in a single image frame is a function of the language being used, the encryption method, the size of the mobile device screen and the size of the reader. Thus, depending on the system and information needed to complete a transaction, one or more image frames may be used. Moreover, it should be understood that the order of the displayed images is not fixed, and is only limited by the parameters of the system being used. In other words, the final language should not presume fixed or finite image frame density, limit the invention to possible data structures, data content, force a particular data-to-frame assignment, or imply a specific order of sequencing of resultant frames. Conversely, nothing in this disclosure should preclude underutilization of image frames with respect to their potential data density, and thus inflation in the number of image frames for the purpose or convenience of segregating data type to individual dedicated frames.

In some embodiments, the security of a transaction can be increased by encoding information specific to the hand held device in the data transmitted to the mobile module or POS. For example, GPS information from the phone can be encoded with the payment information and transmitted to the mobile module. The received GPS information can be compared to GPS information contained within the mobile module to ensure that the data being generated by the customer's handheld device is fresh and is not a reproduction of images obtained during a transaction at another geographical location.

In yet other embodiments, the security of a transaction can be increased by encoding date and/or time information specific to the hand held device in the data transmitted to the mobile module or POS. For example, date and/or time information from the phone can be encoded with the payment information and transmitted to the mobile module. The received date/time can then be compared to date/time information contained within the mobile module to ensure that the data being generated by the customer's handheld device is fresh and is not a reproduction of images obtained during a transaction at another geographical location. In other embodiments, the mobile identification number of the handheld device may be transmitted with the payment information as a security measure.

In yet other embodiments, requesting secure data already encode in real-time from a remote server can increase the uniqueness and/or security of a transaction. Also, data may be retrieved and stored for later use until such time that it has exceed an expiration time/date or has exceeded a preset number of uses. For example, to provide uniqueness to the transaction, ten pin blocks may be requested and downloaded from a remote server to allow only 10 individual transactions in a given period of time. The retrieved data would then be discarded when the cell phone or other handheld device has utilized the ten transactions and/or the preset expiration date/time has been reached.

Referring to FIG. 6, one possible embodiment of an image reader is illustrated, that being a mobile module with a small package footprint. The embodiment may further contain other payment methodologies including, but not limited to, a BLUETOOTH module, near field communication (NFC), which is a two-way communication technology based on RFID, but it is sometimes called “contactless” technology used for “fast-lane” payment at gas stations and supermarkets, for transit payments, in conjunction with a unidirectional image receiver and/or a bi-directional screen capable of both displaying and receiving optical information. One example of a bi-directional screen is the new System LCD equipped with touch screen and scanner functions, manufactured by Sharp Corporation of Japan, which builds an optical sensor into each pixel of the LCD panel.

The mobile module may also contain a USB, serial connection or any other communications interface to transmit information to (or from) a local computer, server or central server. The mobile module may also be equipped with an AC power connector or other power source connector and/or cabling. The various internal interfaces allow the mobile module to communicate with or receive information from any handheld device having at least one of a camera, NFC, BLUETOOTH, a visual display such as a LCD, or other type of electrical, magnetic or visual communication device.

In one embodiment for connecting with a POS (FIG. 6), the mobile module can be mounted on a counter and connected into the POS terminal either through a USB connection, a serial port connection or any wireless method between the mobile module and the POS. The mobile module allows for one or more of unidirectional and bi-directional communication between the POS and a mobile device having at least one of the following communication mechanisms: NFC, BLUETOOTH, wi-fi, visual display such as a LCD and/or a camera. The amount of interaction over the mobile phone can range from the current NFC information required to complete a transaction to the other extreme where all transaction screens are displayed on the mobile device.

In a bi-directional embodiment of the present invention, the system may transmit coupon or product information to the customer's PDA or cell phone, while receiving payment information. In the alternative, by transmitting an e-mail address to the POS, the system may be configured to send information to the customer using the e-mail address. Moreover, if the system contains a loyalty program, loyalty points may be accumulated or coupons or other direct advertising may be sent to the e-mail address associated with the loyalty account.

In another embodiment where the mobile module connects with a fuel dispenser/kiosk, the mobile module may be mounted on or in a fuel dispenser and connected to the electronics of the fuel dispenser through the serial or USB ports, wireless or other means of standard communication mediums. Once again the mobile module allows for unidirectional or bi-directional communications between the mobile device and dispenser/kiosk, when the mobile device is equipped with an NFC, BLUETOOTH, LCD or camera. The level of information displayed on the mobile device can range from that of current NFC information to a dispenser/kiosk screen being displayed on the mobile device screen. In addition, the mobile module may read images displayed on a handheld device screen as described above with respect to FIGS. 1-5.

In yet another embodiment, the mobile module may be used with legacy fuel dispensers that are already in the field. The mobile module may be mounted to the fuel dispenser and powered by the dispenser electronics. Thus, similar to the embodiment where the mobile module is mounted within the dispenser, transaction information may be transmitted between a customer's handheld device and the dispenser POS terminal.

The above described embodiments allow for the payment of transactions through visual data displayed by a customer's handheld device, such as a PDA or cell phone. In addition to making payments through credit/debit cards, payment for a transaction may also be linked to a customer's cell phone bill or a PayPal type web payment system. For example, in one embodiment, the mobile module may display a one- or two-dimensional bar-code or graphically encoded rendering of “data” or “indicia” (hereinafter “code”) that can be read or received by the customer's handheld device. Examples of two-dimensional codes include, for example, a QR Code (two-dimensional bar code) created by Denso-Wave of Japan or a mCode created by Nextcode of Concord, Mass. It should be understood that any form of two dimensional codes may be used in the present invention, where one or more images contain the necessary information to complete the transaction. The code may contain static information that identifies the specific mobile module, or the code may contain dynamic information that contains specific information regarding the mobile module and the current transaction. In either case, the customer may scan the code with their handheld device to obtain information that allows the customer to complete the transaction directly on their handheld device.

In particular, the code may provide information about the mobile module, the current transaction and a URL webpage address. The handheld device can be configured to capture this information and open the associated webpage in the handheld's browser. Through the webpage, the customer can enter information that completes the transaction, such as a credit card number, Pay Pal account information or any other payment information without having to enter the information directly into the POS. As a result, customer information would not have to be provided to store clerks or others working at the store, thereby reducing the likelihood of identity theft and/or stolen payment information. It should be understood that instead of completing the transaction on a web based page, a program resident on the handheld device may be used to complete the transaction where the payment information is transmitted to a remote server via the wireless connection between the handheld device and the mobile module or POS terminal.

In any one of the above described embodiments, the mobile module may include, either integrated therein or attached thereto, a laser barcode reader for reading typical one and two-dimensional line barcodes. The combination of laser and optical readers allows the mobile module to read various barcode schemes. Thus, as the marketplace migrates from laser barcodes to denser two dimensional optical codes, mobile modules of the present invention will provide a means to read both optical and laser barcode schemes. Typical barcode scanners include, but are not limited to, scanners made by NCR, Inc. (NCR Model 7890), which projects seven groups of three parallel lines each.

The mobile module may be configured in one of many ways as described herein. For example, the mobile module may be configured to select a transaction methodology based on the capabilities of the customer's handheld device. Moreover, the mobile module may also be configured to complete a transaction based on the payment methodology chosen by the customer. In some embodiments, the transaction may be completed by combining one or more of the data transmission methods. For example, displayed images in combination with data transmitted via BLUETOOTH or NFC can be combined to complete a transaction,

While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to these embodiments since modifications can be made. Therefore, it is contemplated that any and all such embodiments are included in the present invention as may fall within the scope and spirit thereof.

What is claimed:

1. A method for conducting a transaction at a point-of-sale terminal, the method comprising:
a. conducting a transaction at a point-of-sale terminal;
b. generating at least one encoded image pattern on a display device, said encoded image pattern comprising a plurality of contrasting colored squares that together represent encoded information for completing said transaction;
c. placing said display device adjacent a two-dimensional image reader;
d. reading said at least one encoded image pattern;
e. deciphering said at least one encoded image pattern to extract said information for completing said transaction; and
f. using said information to complete said transaction.

2. The method for conducting a transaction of claim 1, wherein said two dimensional reader is built into a handheld device and said at least one encoded image pattern is generated by the point-of-sale terminal.

3. The method for conducting a transaction of claim 2, wherein said handheld device is a cellular telephone.

4. The method for conducting a transaction of claim 1, wherein said encoded information comprises at least one of payment information and transaction information.

5. The method for conducting a transaction of claim 1, wherein said two-dimensional reader is operatively coupled to the point-of-sale terminal and the step of generating at least one encoded image pattern is carried out on a handheld device.

6. The method of conducting a transaction of claim 4, wherein said encoded information further comprises credit card information and personal security information for completing the transaction.

7. The method of conducting a transaction of claim 6, wherein said personal security information is at least one of GPS information, time and date information, handheld device information and PIN information.

8. The method of conducting a transaction of claim 4, wherein said encoded information further comprises a website link.

9. The method of conducting a transaction of claim 8, further comprising the step of entering payment data on a webpage associated with said encoded webpage link.

10. The method off conducting a transaction of claim 2, wherein a display on said handheld device functions as a scanner for reading said at least one coded image.

11. The method off conducting a transaction of claim 2, wherein a camera built in to the handheld device functions as a scanner for reading said at least one coded image.

12. The method off conducting a transaction of claim 5, wherein said reader is a camera.

13. A method for conducting a transaction at a point-of-sale terminal, the method comprising:
a. providing
i. a point-of-sale terminal having a display screen; and
ii. a reader for scanning an encoded image;
b. conducting a transaction at said point-of-sale terminal;
c. generating at least one two-dimensional encoded image pattern on a display of a handheld device, said two-dimensional encoded image pattern comprising information for completing said transaction;
d. placing said handheld display adjacent said reader;
e. reading said at least one two-dimensional encoded image pattern;
f. deciphering said at least one two-dimensional encoded image pattern to extract said information for completing said transaction; and
g. using said information to complete said transaction.

14. The method for conducting a transaction of claim 13, wherein said at least one two-dimensional encoded image pattern comprises payment information and personal security information.

15. The method of conducting a transaction of claim 14, wherein said at least one two-dimensional encoded image pattern further comprises credit card information and said personal security information is at least one of GPS information, time and date information, handheld device information and PIN information.

16. The method of conducting a transaction of claim 13, further comprising transmitting additional payment information from a handheld device to said POS terminal via a wireless connection.

17. An apparatus for conducting a transaction at a point-of-sale terminal, said apparatus comprising:
a. a processor;
b. memory operatively coupled to said processor;
c. a display screen operatively coupled to said processor and configured to display transaction information;
d. a reader operatively coupled to said processor and configured to read a first two-dimensional encoded image pattern, said first two-dimensional encoded image patient comprising payment information and personal security information to complete said transaction;
wherein said processor is configured to
decipher said first two-dimensional encoded image pattern to obtain said payment information and personal security information; and
complete said transaction based on said payment information and said personal security information.

18. The apparatus for conducting a transaction at a point-of-sale terminal of claim 17, wherein said personal security information comprises at least one of GPS information, time and date information, handheld device information and PIN information.

19. The apparatus for conducting a transaction at a point-of-sale terminal of claim 17, wherein said first two-dimensional encoded image pattern further comprises a plurality of light and dark squares that together form two-dimensional barcode.

20. The apparatus for conducting a transaction at a point-of-sale terminal of claim 17, wherein said reader is a camera.

21. The apparatus for conducting a transaction at a point-of-sale terminal of claim 17, wherein said display screen is configured to display a second two dimensional encoded image pattern generated by said processor, said second two dimensional encoded image pattern comprising transaction information that is readable by a handheld device that generates said first two-dimensional encoded image in response to said second two dimensional encoded image pattern.
